(19) United States
(12) Patent Application Publication
(10) Pub. No.: US 2005/0242039 A1
(43) Pub. Date: Nov. 3, 2005

(54) Deposition of dissolved analyte to hydrophobic surfaces by desolvation of organic solvents

(75) Inventor: Daniel B. Wall, Salem, MA (US)

Correspondence Address: WATERS INVESTMENTS LIMITED;C/O WATERS CORPORATION, 34 MAPLE STREET - LG, MILFORD, MA, 01757, US

(73) Assignee: WATERS INVESTMENTS LIMITED, New Castle, DE (US)

(21) Appl. No.: 11/109,394

(22) Filed: Apr. 19, 2005

Related U.S. Application Data
(63) Continuation of application No. PCT/US03/33677, filed on Oct. 21, 2003.
(60) Provisional application No. 60/420,391, filed on Oct. 21, 2002.

(51) Int. Cl. C02F 1/28

(52) U.S. Cl. 210/656

(57) ABSTRACT

The present invention provides a method of depositing an analyte of interest on a hydrophobic surface, e.g., DIOS-MS substrates, by desolvating organic solvents from the aqueous analyte solution prior to deposition.

### CROSS REFERENCE TO RELATED APPLICATION

This application claims the benefit of U.S. provisional patent application Ser. No. 60/420,391 filed Oct. 21, 2002 and PCT application Ser. No. PCT/US03/33677, filed Oct. 21, 2003. The entire contents of which are expressly incorporated herein by reference.

### BACKGROUND OF THE INVENTION

Mass spectrometry (“MS”) is routinely used to measure the molecular weight of a sample molecule, as well as the fragmentation characteristics of a sample to identify that sample. MS may be carried out in the gas phase in which an electrically neutral sample at low pressure is passed through an electron beam. The electron beam strikes the sample and ejects one or more electrons after which the sample is ionized with a net positive charge. The ionized sample is then passed through a magnetic field and, depending on the course of the ionized sample through that field, the mass of the molecule to the ion's electric charge is measured.

Another technique for measuring the mass of the sample is time-of-flight (“TOF”). In TOF, a sample ion is accelerated by a known voltage, and the time it takes a sample ion or fragment thereof to travel a known distance is measured.

Molecules that are not readily put in the gaseous phase are more difficult to analyze by MS. Several techniques exist for volatilizing high molecular weight samples. When a sample molecule is deposited on a substrate, the sample is said to be adsorbed to that substrate. Desorption occurs when a molecule adsorbed on a substrate is removed from the substrate. Instead of starting with a gas phase sample, as in basic MS, desorption MS may be applied to a sample adsorbed on a substrate.

One desorption MS technique is matrix-assisted laser desorption/ionization (“MALDI”). In accordance with this technique, a sample is ionized by transferring a proton from an organic matrix to the sample as part of the vaporization process. Ionization of the sample is achieved by electron beam ionization or proton transfer ionization.

In a typical MALDI experiment, a sample is dissolved into a solid, light-absorbing organic matrix that vaporizes upon pulsed laser radiation, carrying the sample with the vaporized matrix. Although it is a widely used and powerful technique, MALDI is not generally appropriate for the study of small molecules because the matrix interferes with measurements below a m/Z, i.e., mass to charge ratio, of about 700. MALDI also has significant limitations in the analysis of large molecules because, for example, the matrix can form adducts with the sample ion and thereby interfere with the analysis.

Newer MS techniques permit a direct laser desorption/ionization technique in the absence of a matrix. Such methods include ionization of an analyte on a porous light-absorbing semiconductor by irradiating the analyte-loaded substrate under reduced pressure. See, e.g., U.S. Pat. No. 6,288,390 and the corresponding international PCT application WO 00/54309. According to such direct desorption MS methods, the porous semiconductor substrate, e.g., silicon, is bonded with hydrophobic groups, e.g., ethyl phenyl groups. The sample is placed on a substrate and then irradiated with ultraviolet light, optionally with an applied voltage. The benefit of such methods is that the use of a matrix is not required, so that the methods are more amenable to small molecule analysis.

Additionally, analytes may be directly detected without a matrix. The substrate may be chemically or structurally modified to optimize the desorption/ionization characteristics of the substrate. Several examples of desoprtion/ionization on porous silicon (“DIOS”) MS substrates are described in Z. Shen, Anal. Chem., 73, 612-19 (2001); J. J. Thomas, Proc. Nat. Acad. Sci. USA, 98, 4932-37 (2001); and R. A. Kruse, Anal. Chem., 73, 3639-45 (2001). The analysis of whole cells by DIOS-MS has also been demonstrated. R. A. Kruse, J. Mass Spectrom., 36, 1317-32 (2001).

Despite the promise of DIOS-MS techniques, the method is limited by the number of samples that can be applied to one substrate. In typical laboratory conditions, an analyte solution comprises a substantial amount of organic solvent, e.g., an HPLC fraction in which the chromatographic separation was carried out using a mixed organic/aqueous solvent system. This represents a major problem with DIOS-MS in that one often desires to apply a sample containing high amounts of organic solvents such as, e.g., acetonitrile. Because DIOS-MS substrates are hydrophobic, a similarly hydrophobic sample when placed on the substrate will spread out. Because the contact angle of these solutions is less than 90°, the sample spreads out over a large portion of the DIOS chip due to wicking. This not only limits the number of samples that can be placed on a substrate, but also compromises the sensitivity of the MS analysis.

### SUMMARY OF THE INVENTION

Porous silicon used for DIOS-MS substrate is hydrophobic. Aqueous samples work particularly well when used for DIOS-MS, because when the sample is applied, it beads up and does not spread out because the contact angle of the aqueous sample on silicon DIOS chips is greater than 90°. The present invention overcomes the above-described problems in the prior art by removing the organic solvents during deposition of samples on DIOS-MS substrates. As a result, the spreading effect which leads to decreased sensitivity as well as reduction in the number of samples that can be deposited to one chip is overcome.

The present invention exploits the fact that typical organic solvents used for sample deposition in LDI experiments are more volatile than water. Thus, if analyte is dissolved in a solution containing organic solvents and water, and then subjected to rapid desolvation during sample deposition, the organic solvents will evaporate faster that the water. The analyte then is deposited onto a hydrophobic surface, e.g., DIOS-MS chip, in a solvent mixture that is primarily aqueous in nature, and that has a contact angle of greater than 90°. Deposition to the hydrophobic surface in an aqueous solution will minimize any hydrophobic wicking effects and allow the analyte to be focused into a significantly smaller area thus increasing sensitivity and the number of samples that can be deposited to a given area of the surface. The deposition method herein has the unique ability to selectively remove organic solvents while depositing a primarily aqueous sample solution to the hydrophobic surface.

Thus, the present invention provides a method for depositing an analyte on a hydrophobic surface. The method comprises the steps of preparing an analyte solution by dissolving the analyte in a solvent comprising a mixture of water and one or more organic solvents; desolvating the organic solvents from the analyte solution under conditions sufficient to provide a primarily aqueous analyte solution; and depositing the desolvated primarily aqueous analyte solution onto the hydrophobic surface.

The invention also provides a kit comprising a DIOS chip and/or a mass spectrometry instrument and instructions for use thereof according to the method the invention summarized above.

The invention still further provides a method for preparing a sample for mass spectrometric analysis by depositing an analyte on a hydrophobic surface. The method comprises the steps of preparing an analyte solution by dissolving the analyte in a solvent comprising a mixture of water and one or more organic solvents; desolvating the organic solvents from the analyte solution under conditions sufficient to provide a primarily aqueous analyte solution; and depositing the desolvated primarily aqueous analyte solution onto the hydrophobic surface, to thereby prepare the sample for mass spectrophotometric analysis.

### DETAILED DESCRIPTION OF THE DRAWINGS

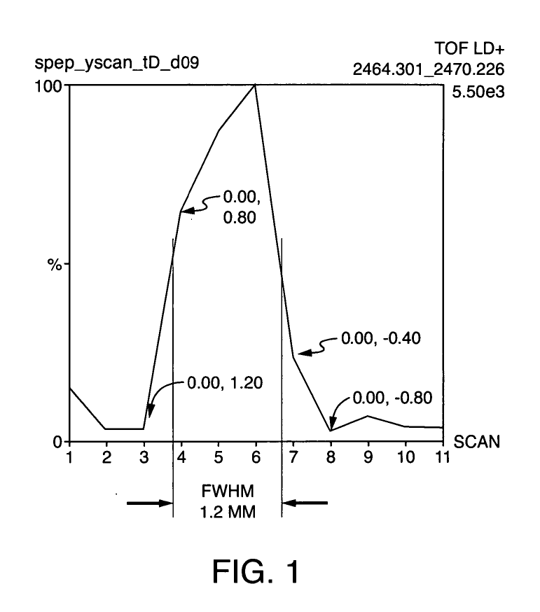

FIG. 1 is a plot of the Y dimension of material deposited onto a DIOS substrate by the methods of the invention;

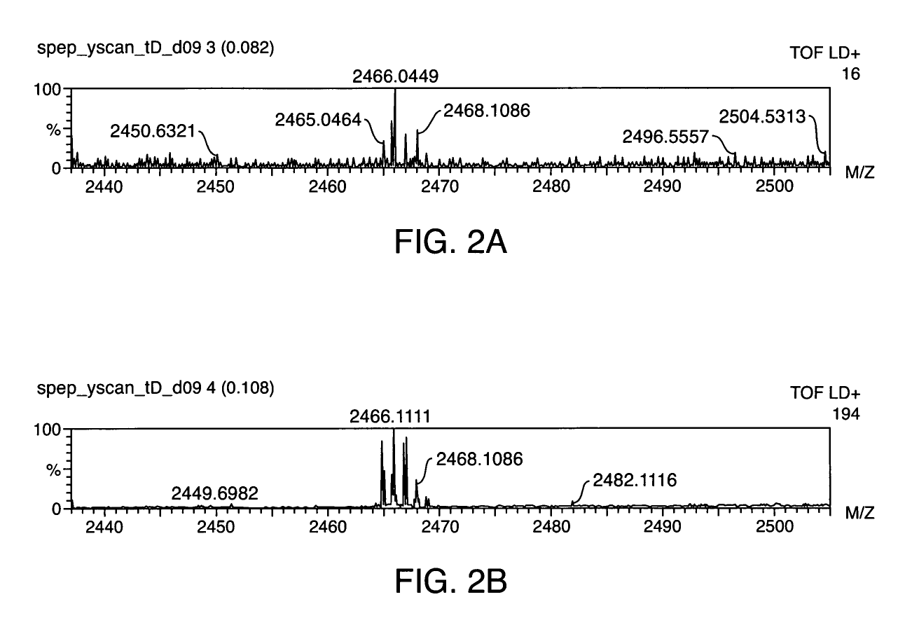

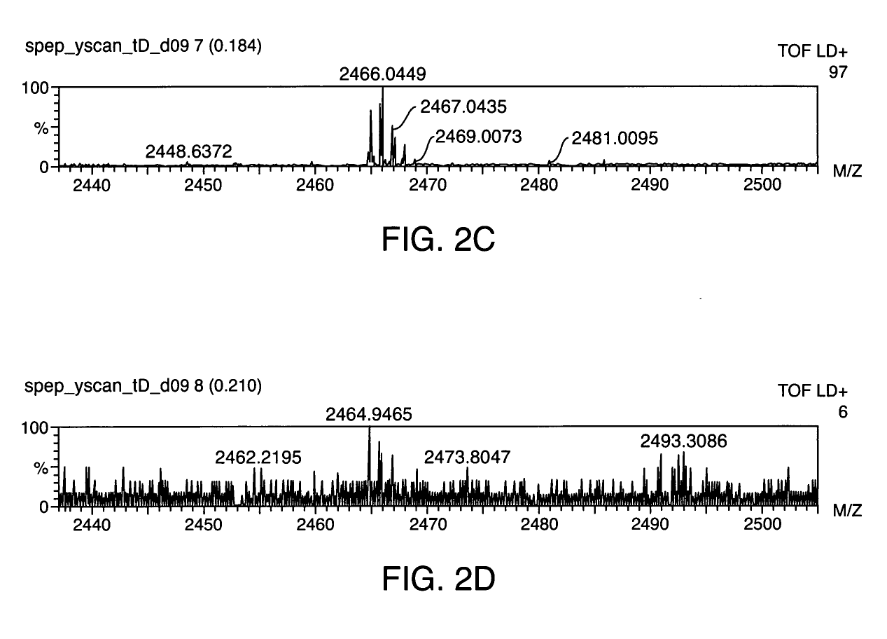

FIG. 2A-D is a series of mass spectra from the middle and edges of this cross-track;

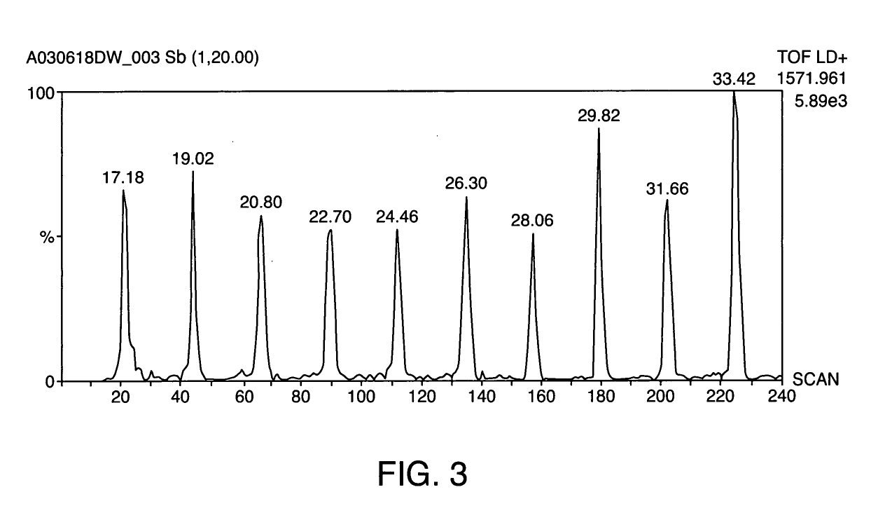

FIG. 3 is a Raster profile of consecutive sample well depositions from the prep-LC-MALDI (consecutive peaks represent consecutive wells: i.e. A2, A3, A4, etc . . . (4.5 mm pitch));

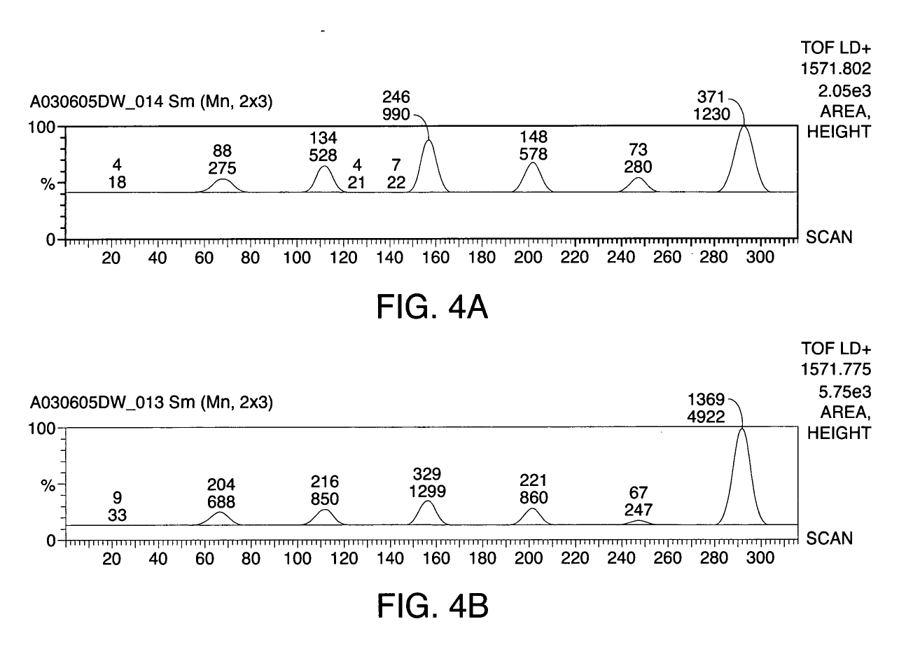

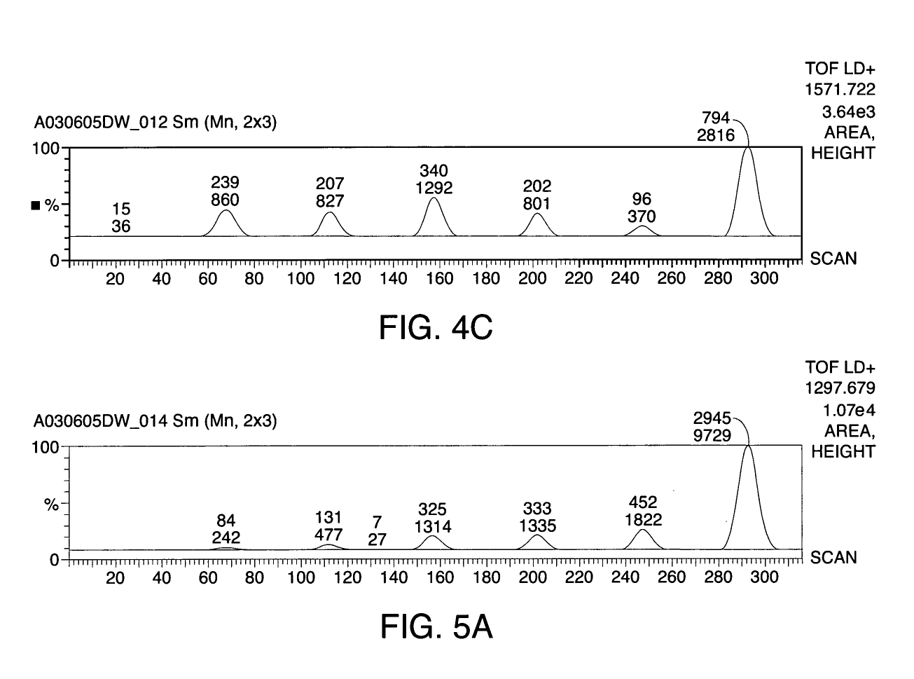

FIG. 4 is plot of SIC peaks from Glu-fib (100 fmol/μL);

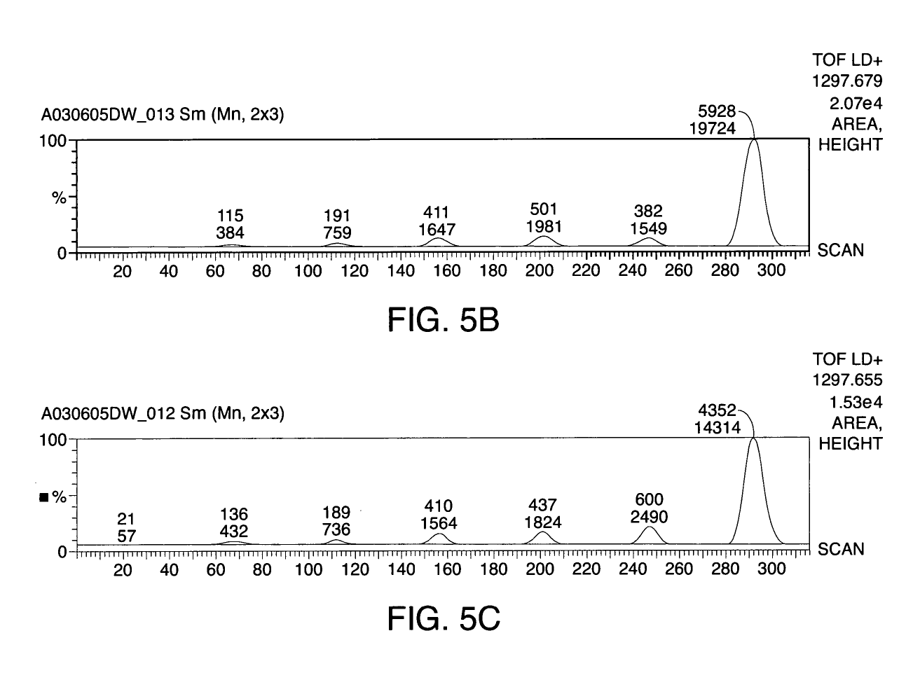

FIG. 5 is plot of SIC peaks from Angiotensin I (25, 50, 100, 500, and 1000 fmol/μL);

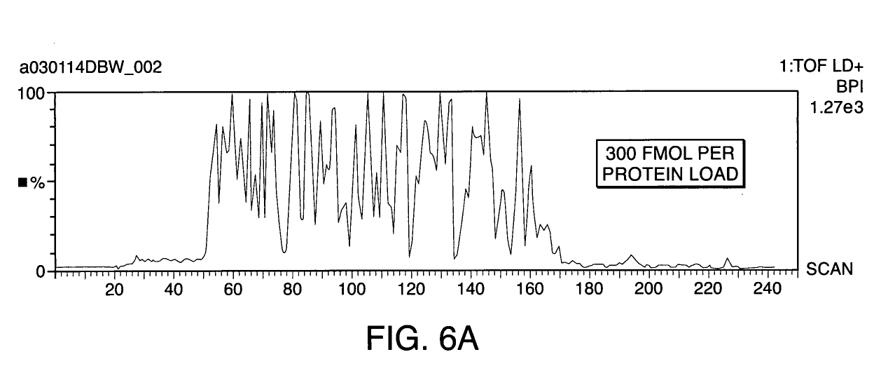

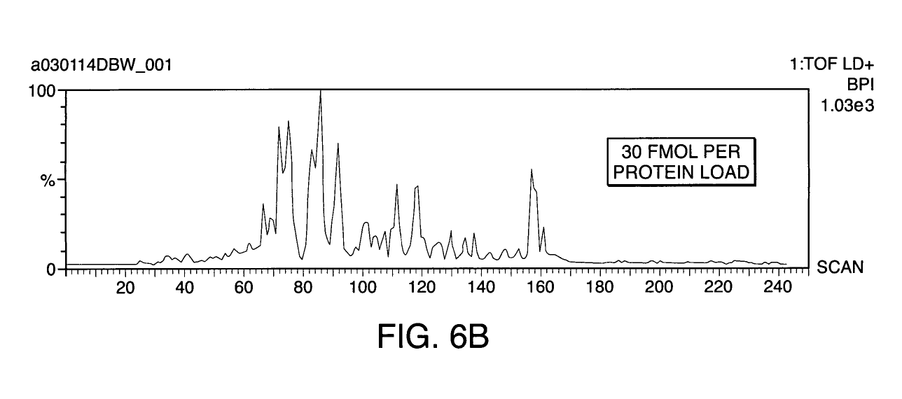

FIG. 6. is a CapLC-MALDI-MS base peak chromatograms of a trypsin digestion of four proteins;

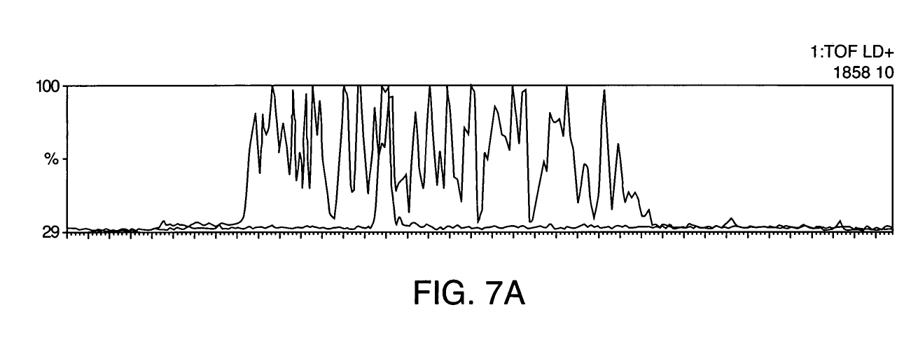

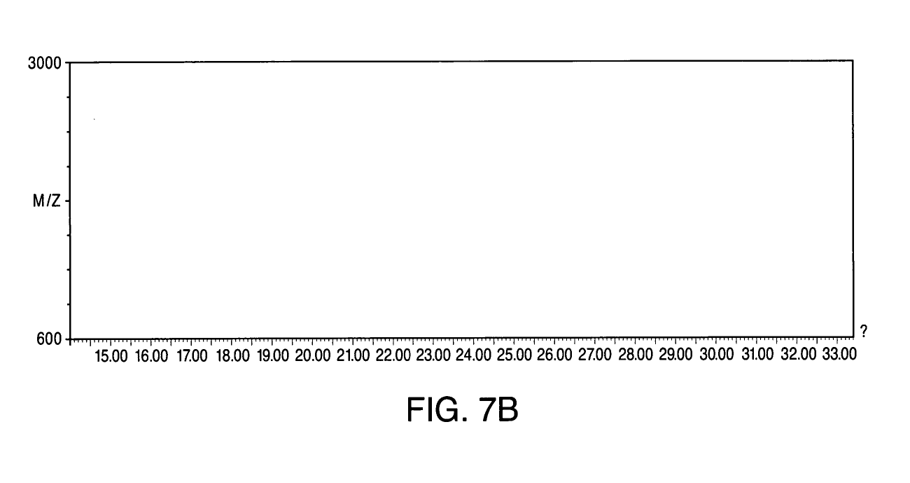

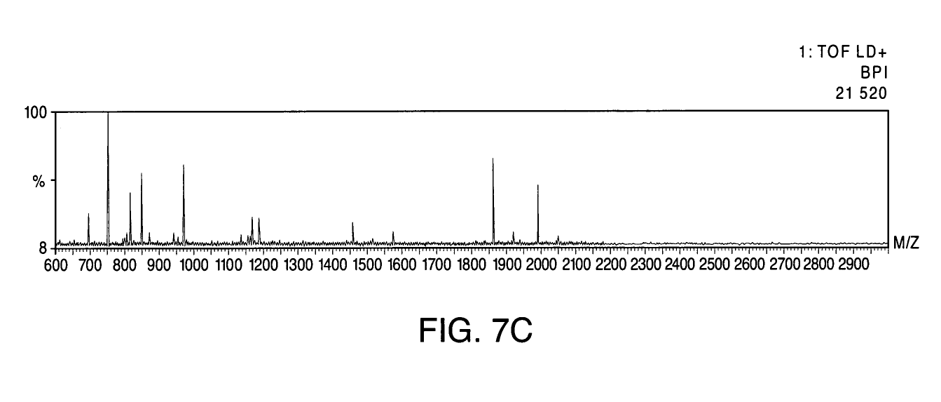

FIG. 7 is a two dimensional mapping of the LC-MALDI separation for the protein mixture of FIG. 6 at a loading of 300 fmol/protein;

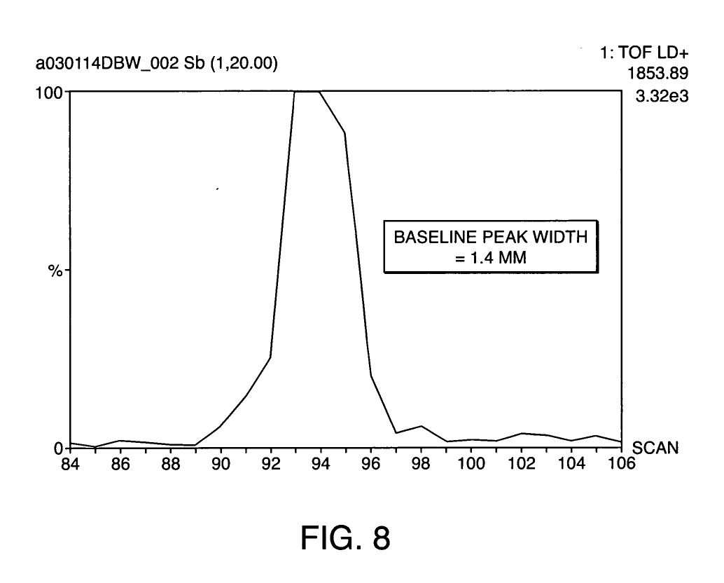

FIG. 8 is an extracted ion chromatogram showing the focus of peptide deposition onto the DIOS chip;

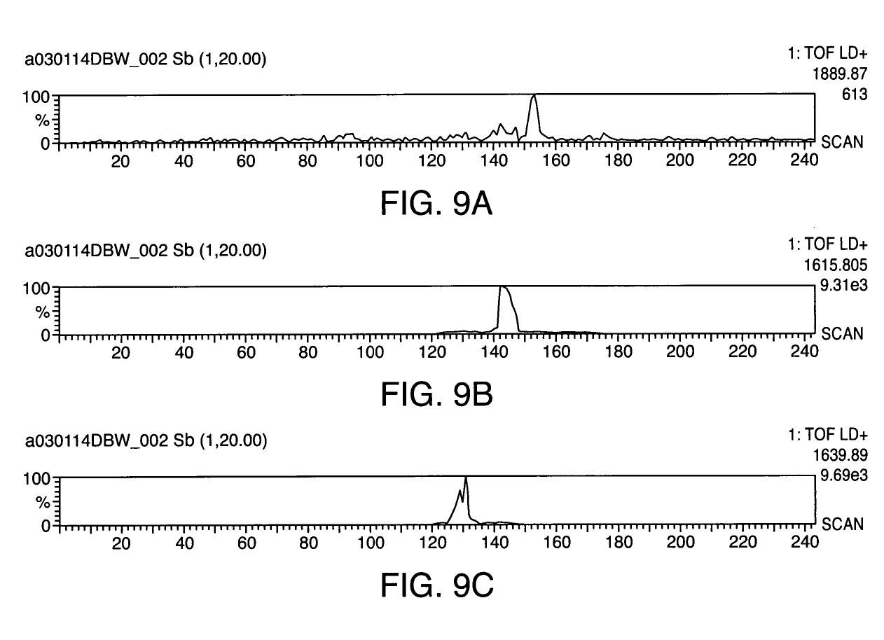

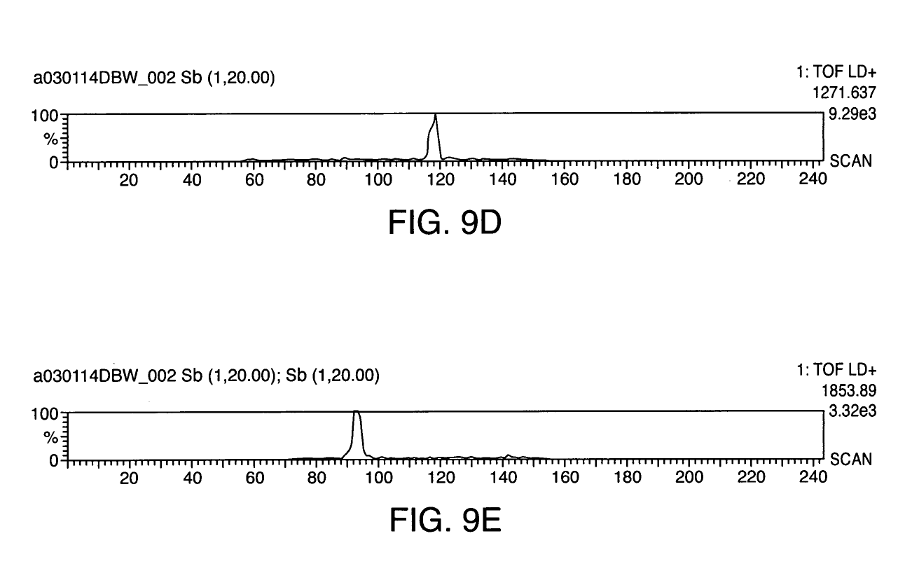

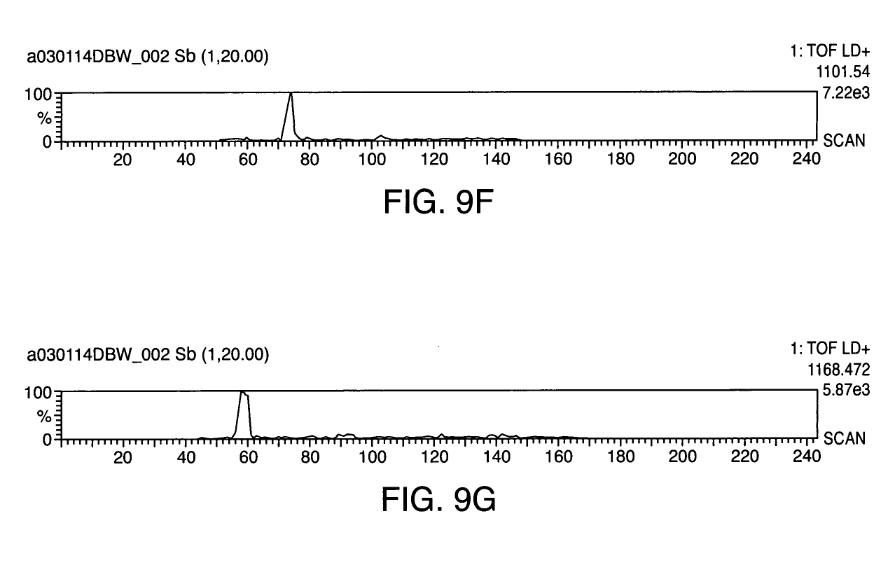

FIG. 9 is a selection of various XIC which illustrates the spatial separation of analytes deposited on a DIOS chip using LC-MALDI separation.

### DETAILED DESCRIPTION OF THE INVENTION

The present invention provides a method for depositing an analyte on a hydrophobic surface. The method comprises the steps of preparing an analyte solution by dissolving the analyte in a solvent comprising a mixture of water and one or more organic solvents; desolvating the organic solvents from the analyte solution under conditions sufficient to provide a primarily aqueous analyte solution; and depositing the desolvated primarily aqueous analyte solution onto the hydrophobic surface.

In accordance with the invention, the analyte may be generally any laboratory sample of a broad range of molecular weights, e.g., up to 1 million Daltons, such as a biological sample, including but not limited to a nucleotide or mixture of nucleotides, a protein or mixture of proteins, or a peptide or mixture of peptides. Likewise, the analyte may be a synthetic polymer or mixture synthetic polymers.

In one embodiment of the invention, the hydrophobic surface comprises a porous semiconductor, e.g., based on silicon, gallium arsenide, or gallium nitride. In a particular embodiment, the porous semiconductor is a Desorption/Ionization on Silicon (“DIOS”) chip. DIOS chips are described in, for example, J. Wei, Nature, 399, 243-46 (1999); G. E. Siuzdak, PCT W0 00/54309; and G. E. Siuzdak, U.S. Pat. No. 6,288,390.

Typically samples containing organic solvents tend to spread out over a wide area on a DIOS chip leading to poor sensitivity and reduction in the number of samples that can be run on a given DIOS chip. This is a result of the fact that organic solutions tend to form a contact angle of less than 90°. Aqueous solvents do not cause spreading of the sample over a wide area of the DIOS chip.

The methods of the present invention preferentially remove organic solvents rather than aqueous solvents during sample deposition by desolvation. The terms “desolvating” and “desolvation” are used interchangeably herein, and are intended to mean the removal of one or more organic solvents from an analyte solution comprising a mixture of water and one or more organic solvents so that the analyte solution is primarily aqueous following desolvation in accordance with invention.

The terms “primarily aqueous” as in “primarily aqueous analyte solution” refers to an analyte solution that, when deposited onto a hydrophobic surface, does not wick or spread out along the surface so as to compromise (e.g., decrease sensitivity) the analysis (e.g., mass spectrometric analysis) of the analyte. In short, the primarily aqueous analyte solutions that are desolvated in accordance with the invention avoid the problems associated with prior art methods of sample preparation and deposition by increasing the sensitivity of the analysis and increasing the number of samples that can be analyzed.

In one embodiment of the invention, the organic solvent content of the desolvated, primarily aqueous analyte solution is such that when deposited on an hydrophobic surface, the desolvated, primarily aqueous analyte solution will have an angle of contact with the surface of greater than about 90°. The contact angle may be measured using a variety of standard laboratory techniques, such as explained in, e.g., Physical Chemistry of surfaces, Adamson, Arthur W., Department of Chemistry, University of Southern California, Los Angeles, Calif., Interscience Publishers, A division of John Wiley and Sons, New York, p355, “measurement of contact angle.” In certain embodiments, the angle of contact ranges from greater than about 90° to about 115°. Typically, the organic solvent content in the desolvated, primarily aqueous analyte solutions according to the invention ranges from about 5% to about 10% by volume of the analyte solution.

In one embodiment, the analyte solution is desolvated by thermospraying, e.g., by rapidly infusing the analyte solution through a heated capillary nebulizer, such as that described in K. Biemann, U.S. Pat. No. 4,843,243; T. Prevost, U.S. Pat. No. 5,772,964; K. Biemann, U.S. Pat. No. 5,770,272, at a temperature, a pressure, and a rate sufficient to provide a primarily aqueous analyte solution. The exact conditions will depend on the particular analyte, and determination of optimal conditions will be well within the understanding and of one of ordinary skill in the art. The solution should be heated sufficiently rapidly to remove organic solvent, preferably in a reproducible manner, without significantly removing water or causing the sample to thermally degrade. By way of example, the temperature may be about 30-200° C. (or 30-150° C.), the pressure about 10-60 PSI (or 10-30 PSI), and the rate about 0.05-50 μL/min (or 0.1-20 μL/min).

The organic solvents are preferentially removed due to desolvation during deposition by the heated capillary nebulizer, leaving the analyte dissolved in a primarily aqueous solution. Samples deposited to DIOS chips in a primarily aqueous solution will tend to stay within a confined region of the chip and not spread out over a large area of the chip, thus leading to increased sensitivity and numbers of samples that can be collected on one DIOS chip. Methods of the invention using a heated capillary nebulizer are capable of depositing an analyte onto a DIOS surface with a track width of about 0.3 mm (e.g., a track width of about 1 mm to about 0.1 mm) and having a gain in spatial focus of at least two fold compared to a traditional pipette deposition method onto a 2.5 mm well(more preferably between about 2.5 and about 6.5 fold gain in spatial focus). Thus, the method of the invention may be used, e.g., for preparing a sample for mass spectrometric analysis, in which case samples may be deposited in a series of adjacent tracks or spots.

The organic solvent which is desolvated may be acetonitrile, an organic alcohol (e.g., methanol, ethanol, or isopropanol), an ether (e.g., diethylether), tetrahydrofuran, dichloromethane, chloroform, hexane, heptane, cyclohexane, ethyl acetate, benzene, toluene, and mixtures thereof.

The analyte solution may also comprise an ion pairing agent, e.g., such as those conventionally used in HPLC solvent systems, including formic acid, acetic acid, and trifluoroacetic acid.

In one exemplary embodiment, the analyte solution comprises about 10-70% acetonitrile, about 10-70% water, and about 0.1-2.0% trifluoroacetic acid.

The present invention also provides a kit comprising a DIOS chip and/or mass spectrometry instrument and instructions for carrying out a method of the invention. A suitable mass spectrometry instrument for use in the methods of the invention is the LC-MALDIprep™ (Waters Corporation, Milford, Mass.).

The deposition methods of the invention are suitable for use in analyte deposition of proteins and digested proteins for a variety of analytical techniques including peptide mass fingerprinting analysis. More particularly, the mass spectra data obtained by LC-MALDI or LC-MALDI prep are suitable for the acquisition and analysis of protein digest separations and peptide mass fingerprinting analysis.

### EXAMPLES

The present invention may be further illustrated by the following non-limiting examples describing an application of the method of the invention.

### Example 1

Standard peptides were directly infused (Harvard syringe pump) into the LC-MALDIprep (Waters) where they passed through a heated capillary nebulizer and were then deposited onto the DIOS chip in a series of adjacent tracks (4.5 mm spacing). The standard peptides (1 pmol/μL) were directly infused at a flow rate of 10 μL/min in a solution of 30% acetonitrile, 70% water, and 0.1% TFA. Temperature of desolvation was 55° C. and the nitrogen nebulizer gas was held at a pressure of 20 PSI. The distance between the nozzle and the DIOS chip was 10 mm. The stage speed during sample collection was 10 mm/min. The mass spectral analysis was done using a Micromass MALDI® instrument (Micromass UK, Ltd.). The laser was scanned across the Y-dimension of the track (spep_yscan_tD_d09) thereby measuring the width of the track (FIG. 1). The LC-MALDIprep (Waters) produces a spray of 1 mm diameter.

The data show that the sample sprayed down onto the DIOS chip was focused into a narrow sample track width of 1.2 mm (FWHM) (FIG. 1). The four mass spectra from the middle and edges of this cross-track scan are shown in FIG. 2. Each mass spectrum displays the mass of the peptide infused as well as the x,y position showing where on the DIOS chip, the laser was being fired. From these data the baseline width of the track is 2 mm and the FWHM width of the track is 1.2 mm. The same solution (30% acetonitrile) dropped onto the DIOS chip without desolvation spread over a much large area than occurred with the sprayed sample due to the fact that this solution had a contact angle of less than 90°. The 1.2 mm wide track shows that the sample did not significantly wick out after deposition to the DIOS surface even though it was initially dissolved in 30% acetonitrile. With a flow rate of 10 μL/min and a stage speed (collection rate) of 10 mm/min a column of 1 μL is collected to 1 mm of track. This method of sample deposition can be used to collect tracks or spots of sample to the DIOS chips while minimizing the wicking effects typically seen with the DIOS chips during sample deposition in organic solvent containing solutions.

### Example 2

The following exemplary methods of the invention were carried out using the following techniques and equipment for sample preparation and manipulation.

CapLC
The CapLC was run at 3 uL/min with typical water/acetonitrile/0.1%TFA gradient chromatography. The column used was the Symmetry C18 0.32×150 mm with 5 um particle size.

LC-MALDIprep
The LC-MALDIprep was run with the original stainless steel capillary for the LCDIOS work and with the newer fused silica capillary for the direct infusion spatial focusing work. Typical nozzle temperatures were from 40 to 70 C. Typical stage speeds ranged from 2.5 to 10 mm/m in.

LC-MALDI-TOF/MS
The Micromass MALDI-TOF/MS instrument (Waters) was operated using beta 5 version of SCN429 in MassLynx4.0 and MaldiAuto/PLGS2 for peptide mass fingerprinting.
   Spatial Focusing

The standard peptide, Glu-fibrinopeptide B, was directly infused onto the DIOS chip using the syringe pump. The tracks and spots were scanned with the laser to determine the width of the deposition on the DIOS surface. This width was measured at baseline and FWHM in replicate to determine the degree of spatial focusing. The flow rate is 2 μL/min in 50% acetonitrile, 50% water, 0.1% TFA and 10 mM ammonium citrate unless otherwise noted. The stage is moved at 2.5 mm/min unless otherwise noted. The reference point for spatial focusing is a normal well which is 2.5 mm in diameter. The area of this well is therefore 4.91 mm².

Track widths on DIOS from a direct infusion at 1 μL/min using a picofrit capillary (75×15 um) are on average 0.3 mm FWHM and 0.7 mm baseline (Table 1). At a flow rate of 1 uL/min and a stage speed of 2.5 mm/min a volume of 1 uL is deposited into a track length of 2.5 mm. The area of deposition is therefore 0.7×2.5 mm or 1.75 mm\hat{ }2. This represents a 2.8 X improvement in spatial focus over the normal well area of 4.91 mm\hat{ }2.

TABLE 1
Spatial focus on DIOS

| | | | | | | | | | FWH | Bsin | FWH | Bsin | FWH | Bsin |
|---|---|---|---|---|---|---|---|---|---|---|---|---|---|---|
| | M/D | D | P | T | Dna | Z | v | F | 1 | 1 | 2 | 2 | 3 | 3 |
| PF75 × 15 | MATR | D1 | 10 | 60 | 1 | 5 | 2.5 | 2 | | | | | | |
| PF75 × 15 | DIOS | D1 | 10 | 60 | 1 | 5 | 2.5 | 1 | 0.3 | 0.6 | 0.3 | 0.6 | 0.4 | 0.6 |

| FWH | Bsin | FWH | Bsin | FWH | Bsin | FWH | Bsin | FWH | Bsin | FWH | Bsin | |
|---|---|---|---|---|---|---|---|---|---|---|---|---|
| 4 | 4 | 5 | 5 | 6 | 6 | 7 | 7 | Avg | Avg | Sdev | Sdev | Avg Pk 1 |
| 0.3 | 0.6 | 0.2 | 0.6 | na | na | na | na | 0.3 | 0.7 | 0.1 | 0.1 | 3.00E + 03 |

Spot diameters on DIOS from direct infusion at 2 uL/min using a taper-tip capillary (20×20 um) are 0.4 mm FWHM and 1.0 mm baseline (Table 1). The spot time is 0.5 min so 1 μL is deposited to 1 spot. The area of the spot deposition is 0.79 mm² for a 6.1×improvement in spatial focus.

Quantitative DIOS

Glu-fib was used as the internal standard and held constant at 100 fmol/uL. Angiotensin I was varied in concentration over roughly two orders of magnitude. Replicate measurements were made on the SIC peaks and the ratios used to evaluate the quantitative nature of DIOS with LC-MALDI prep sample deposition.

The parameters used for the peak integration from the LC-MALDI analysis included the following values: Smothing and ApexTrack Peak Integration were enabled; ApexTrack Peak Detection Parameters included a Peak-to-Pea Baseline Noise of 7, a peak width at 5% height of 0.544 (Mins), a Baseline Start threshold of 0.00 and a Baseline end threshold of 0.50%; and chromatogram smoothing used a mean method.

The data was semi-quantitative and further work needs to be done to determine how quantitative the combination of the heated capillary nebulizer and the DIOS chip can be. The table below summarizes the results.

TABLE 2
Summary of quantitative DIOS results.

| | | | Area AT/GF | | Height AT/GF | |
|---|---|---|---|---|---|---|
| ConcGF f | ConcAT f | [AT1]/[GF] | Avg | Stdev | Avg | Stdev |
| 97.6 | 24.4 | 0.25 | 0.7 | 0.3 | 0.6 | 0.2 |
| 95.2 | 47.6 | 0.5 | 0.9 | 0.1 | 0.9 | 0 |
| 90.9 | 90.9 | 1 | 1.3 | 0.1 | 1.3 | 0.1 |
| 97.6 | 243.9 | 2.5 | 2.1 | 0.1 | 2.3 | 0 |
| 95.2 | 476.2 | 5 | 6 | 0.4 | 6.4 | 0.2 |
| 90.9 | 909.1 | 10 | 5.9 | 1.8 | 5.7 | 2 |

LC-DIOS

Separations of a mixture of four proteins digested with trypsin were collected to the DIOS surface using the heated capillary nebulizer. The chromatograms and PMF results follow.

Base peak intensity chromatograms from the LC-MALDI separations are shown in FIG. 6 and a two dimensional mapping of the LC-MALDI separation for 300 fmol load per protein is depicted in FIG. 7. The ability of LC-DIOS to separate and detect a plurality of peptides from a complex mixture is illustrated by the two-dimensional scan provided in FIG. 7. The majority of mass to charge ratio is below about 2000 Da. Each peak or extracted ion chromatogram is about 1.4 mm wide at baseline (FIG. 8). This is the same XIC shown in FIG. 7. A plurality of XIC spectra are depicted in FIG. 9, which illustrates the spatial focusing of analytes deposited onto the DIOS chip from a LC-MALDI separation by the deposition methods of the present invention.

Mass spectrographic separations were analyzed using the MaldiAuto software and PLGS2 to look at the PMF results. The PMF results show good mass accuracy and a strong bias towards to lower m/z peptide as expected.

Incorporation by Reference

The entire contents of all patents, published patent applications and other references cited herein are hereby expressly incorporated herein in their entireties by reference.

Equivalents

Those skilled in the art will recognize, or be able to ascertain using no more than routine experimentation, numerous equivalents to the specific procedures described herein. Such equivalents are considered to be within the scope of this invention and are covered by the following claims.

1. A method for depositing an analyte on a hydrophobic surface comprising the steps of:
preparing an analyte solution by dissolving the analyte in a solvent comprising a mixture of water and one or more organic solvents;
desolvating the organic solvents from the analyte solution under conditions sufficient to provide a primarily aqueous analyte; and
depositing said desolvated, primarily aqueous analyte solution onto said hydrophobic surface.

2. The method according to claim 1, wherein said desolvated, primarily aqueous analyte solution, when deposited on said hydrophobic surface, has an angle of contact with said surface of greater than about 90°.

3. The method of claim 2, wherein said angle of contact ranges from greater than about 90° to less than about 115°.

4. The method of claim 1, wherein the analyte solution is deposited on the hydrophobic surface in a track having a thickness of less than about 1 μm.

5. The method of claim 1, wherein the analyte solution is deposited on the hydrophobic surface in a track having a thickness of between about 0.1 and about 1 μm.

6. The method of claim 1, wherein the analyte solution is deposited on the hydrophobic surface in a track having a thickness of about 0.3 μm.

7. The method of claim 1, wherein said desolvated, primarily aqueous analyte solution comprises an organic solvent content ranging from about 5% to about 10% by volume of the analyte solution.

8. The method according to claim 1, wherein said analyte is a biological sample.

9. The method according to claim 2, wherein said analyte is a protein or mixture of proteins.

10. The method according to claim 2, wherein said analyte is a peptide or mixture of peptides.

11. The method according to claim 1, wherein said analyte is a synthetic polymer.

12. The method of claim 1, wherein said hydrophobic surface comprises a porous semiconductor.

13. The method according to claim 12, wherein said porous semiconductor is based on silicon, gallium arsenide, or gallium nitride.

14. The method according to claim 12, wherein said porous semiconductor is a Desorption/Ionization on Silicon (DIOS) chip.

15. The method according to claim 1, wherein said organic solvent is selected from the group consisting of acetonitrile, an organic alcohol, an ether, tetrahydrofuran, dichloromethane, chloroform, hexane, heptane, cyclohexane, ethyl acetate, benzene, toluene, and mixtures thereof.

16. The method according to claim 15, wherein said organic solvent is acetonitrile, diethylether, methanol, ethanol, or isopropanol.

17. The method according to claim 1, wherein said analyte solution further comprises an ion pairing agent.

18. The method according to claim 17, wherein said ion pairing agent is selected from the group consisting of formic acid, acetic acid, and trifluoroacetic acid.

19. The method according to claim 1, wherein said analyte solution comprises about 10-70% acetonitrile, about 10-70% water, and about 0.1-2.0% trifluoroacetic acid.

20. The method according to claim 1, wherein said organic solvents are desolvated by thermospraying.

21. The method according to claim 20, wherein said organic solvents are desolvated by rapidly infusing the analyte solution through a capillary nebulizer at a temperature, a pressure, and a rate sufficient to provide a primarily aqueous analyte solution.

22. The method according to claim 21, wherein said temperature is about 30-200° C., said pressure is about 10-60 PSI, and said rate is about 0.05-50 μL/min.

23. The method according to claim 22, wherein said temperature is about 30-150° C., said pressure is about 10-30 PSI, and said rate is about 0.1-20 μL/min.

24. The method according to claim 1, wherein said primarily aqueous analyte solution is deposited in a series of adjacent tracks or spots.

25. The method according to claim 1 or 21, wherein said primarily aqueous solution is at most about 10% organic solvent by volume.

26. The method according to claim 25, wherein said solution is at most about 5% organic solvent by volume.

27. A kit comprising a DIOS chip or a mass spectrometry instrument and instructions for use thereof according to the method of claim 1.

28. A method for preparing a sample for mass spectrometric analysis by depositing an analyte on a hydrophobic surface comprising the steps of:
preparing an analyte solution by dissolving the analyte in a solvent comprising a mixture of water and one or more organic solvents;
desolvating the organic solvents from the analyte solution under conditions sufficient to provide a primarily aqueous analyte; and
depositing said desolvated, primarily aqueous analyte solution onto said hydrophobic surface, to thereby prepare a sample for mass spectrometric analysis.
